(19) United States
(12) Patent Application Publication
(10) Pub. No.: US 2016/0232301 A1
(43) Pub. Date: Aug. 11, 2016

(54) METHOD AND SYSTEM FOR PROVIDING A PERSONALIZED EXPERIENCE TO A USER IN A MEDICAL ENVIRONMENT

(71) Applicant: GENERAL ELECTRIC COMPANY, Schenectady, NY (US)

(72) Inventors: Razvan Gabriel Iordache, Buc (FR); Caroline De Cock, Buc (FR); Ludovic Avot, Buc (FR)

(21) Appl. No.: 14/974,899

(22) Filed: Dec. 18, 2015

(30) Foreign Application Priority Data
Dec. 19, 2014 (GB) 1422827.4

(51) Int. Cl. G06F 19/00; G06Q 50/00; H04L 29/06

(52) U.S. Cl. CPC G06F 19/322; H04L 63/08; G06Q 50/01

(57) ABSTRACT

A system for providing a personalized experience to a user in a medical environment, is described. The system comprises an application provisioning server configured to provide at least one application; a user device configured to download the at least one application over a network to the user device and to create a unique personal profile comprising user specific information; a data server configured to provide content data comprising a plurality of ambient parameters in at least one medical environment; and a controller configured to provide user related information and/or ambient parameter for a medical environment based on selected parameter.

### BACKGROUND

The present disclosure relates to a system and method for personalizing and optimizing healthcare procedures.

Since women have a certain risk to develop breast cancer regular screenings are recommended. These screenings are performed in hospitals or radiology centers. Some persons hesitate to make an appointment, since they are afraid of the medical examination. Hence, there is the need to provide information, such that a potential user gets familiar with the given conditions or procedures of the required medical examination.

A further reason why patients may avoid to go to a medical examination are lengthy procedures before the actual medical examination. There is the need to find an appointment and to provide the personal data. Further, forms need to be read or signed in order to secure sufficient patient information concerning the conditions of the specific medical imaging technique. Hence, there is the need to accelerate information flows and to provide platforms for registration without waiting. A further goal of the disclosure is to provide a secure data access. Further, errors when patient data needs to be related to medical data should be avoided.

One way to distract a patient from the discomfort, pain, and anxiety of a mammogram is to stimulate the senses of the patient. Moreover, there is also the need to make the medical environment more comfortable for patients. The medical environment comprises not only the examination room but also the dressing or waiting room. A change of the commonly rather sterile environments would encourage female patients to go to breast screening on a regular basis. There is the need to address the drawbacks of the prior art and to provide a system with an increased acceptability by the users or patients.

### SUMMARY OF THE INVENTION

In one aspect, the present disclosure is directed to a method for providing a personalized experience to a person or user in a medical environment, the method comprising:
providing at an application provisioning server at least one application;
receiving at the application provisioning server from a user device a request to download the at least one application;
downloading from the application provisioning server the at least one application over a network to the user device;
creating at the user device a personal profile comprising user specific information;
providing at a data server content data comprising a plurality of ambient parameters for at least one medical environment;
selecting at the user device at least one ambient parameter provided from the plurality of ambient parameters and associating the selected ambient parameter to at least one user specific information of the personal profile; and
providing by a controller the selected ambient parameter in at least one medical environment based on the at least one user specific information and associated selected ambient parameter.

According to one embodiment of the disclosure the method comprises automatically identifying a user in order to activate the controller based provision of user related information and/or ambient parameter in at least one medical environment.

According to another embodiment of the disclosure after the step of selecting an upload and/or storage of the personal profile is performed, wherein the personal profile is associated with the selected ambient parameter to the data server or a mobile device comprising an identifier.

A mobile device or object may be any portable object comprising electronic devices or other objects as a wristband, watch, card, pen, key, ring or the like. In a preferred embodiment said mobile device or object comprises as identifier a radio frequency transponder. The advantage of the RFID technology is the small size and low costs. Thus, RFID may be embedded in any suitable object. At least one user specific information parameter is stored on the RFID for automatically identifying a person. The information stored on the RFID is contactless readable by a reader comprised in the medical environment. In this way the patient or user has during the identification process the hands free and is not held up by lengthy registration processes.

In another aspect of the disclosure the controller provides in at least one medical environment comprising medical examination rooms, waiting rooms and dressing rooms ambient parameters selected from a group comprising a plurality of visual, audible, tactile, olfactory and/or gustative stimuli.

In yet another aspect, the disclosure is directed to the provision of content data at the data server, which content data are selected from the group, comprising administrative data, technical information, medical data, information retrievable from information system, X-ray imaging data, lab results, healthy advice, continuity of care documents or time data in order to make the next appointment for a mammography examination.

In yet another embodiment of the computer implemented method the controller further displays content data, user specific data or visual information by a projector, a display in at least one medical environment. Said display may have a plurality of display option. Preferred display options are for example a virtual window or a virtual mirror.

In another aspect, the present method further comprises the method step of assigning the personal profile to an individual user via an authentication process in order to establish the user as a member of a social network. Establishing communication in the social network allows the member to exchange information or communicate with one or more members of a social network. Further, according to another embodiment of the method the user can amend the user profile and selected ambient parameters. This update or amendment can be easily done from home using a network.

In another aspect, the present disclosure is directed to providing location data from a mobile user device or from the personal profile comprising residence or working place in order to indicate the location of the closest medical environment.

In another aspect, the present disclosure is directed to connecting to the network by QR (quick response) or flash code technology.

In another aspect, the present disclosure is directed to a computer program product, wherein the computer program product comprises program instructions for carrying out each of the method steps of the disclosure, when said product is executed on a computer. In another aspect, the present disclosure is directed to a computer readable medium storing program instructions, which, when executed by a processor of a computer cause the computer to perform each of the method steps of the disclosure.

In general a computer-readable medium may be, for example, a hard disk, a CD-ROM, diskette a ROM/RAM memory, DVD, a digital source such as a network or the internet or any other suitable means.

In yet another aspect, the disclosure is directed to a system for providing a personalized experience to a user in a medical environment, the system comprising
an application provisioning server configured to provide at least one application;
a user device configured to download the at least one application over a network to the user device and to create a unique personal profile comprising user specific information;
a data server configured to provide content data comprising a plurality of ambient parameters in at least one medical environment; and
a controller configured to provide user related information and/or ambient parameter for a medical environment based on selected parameter.

At least one of the above embodiments provides one or more solutions to the problems and disadvantages of the background art. One technical effect that may be realized in the practice of some embodiments of the described methods and systems is that dataflow efficiencies in processing content data are improved. Further a centralization of data reduces the need of memory capacities. The methods according to the disclosure are fast, reliable and provide a secure personalization method. Moreover, the provision of an automatic identification eliminates the need of lengthy identification processes. Other technical advantages of the present disclosure will be readily apparent to one skilled in the art from the following description and claims. Various embodiments of the present application obtain only a subset of the advantages set forth. No single advantage is critical to the embodiments. Any claimed embodiment may be technically combined with any other claimed embodiments.

### BRIEF DESCRIPTION OF THE DRAWINGS

The accompanying drawings illustrate exemplary embodiments of the disclosure and serve to explain, by way of example, the principles of the disclosure.

FIG. 1 is a diagrammatic illustration of a network based system and method according to an embodiment of the disclosure;

FIG. 2 is a flowchart of an application based method according to another embodiment of the disclosure;

FIG. 3 is a flowchart of a method of localization of the closest medical center according to another embodiment of the disclosure;

FIG. 4 is diagrammatically illustrating a website for users of a medical environment and a card comprising an identifier; and

FIG. 5 is diagrammatically illustrating a method to connect to a network through QR-technology.

### DETAILED DESCRIPTION

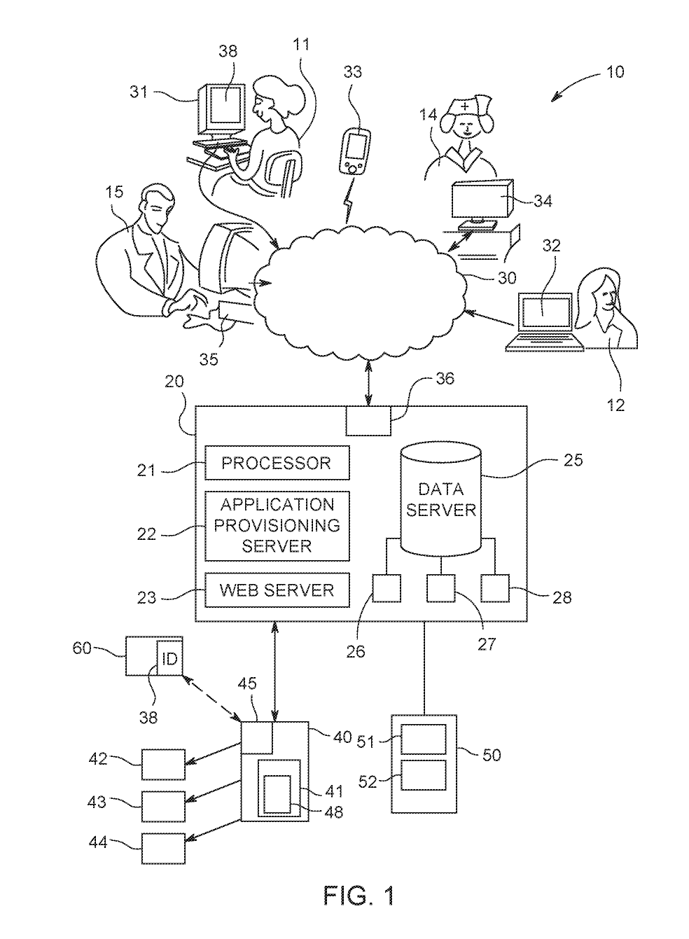

FIG. 1 depicts diagrammatically a network based system and method according to an embodiment of the disclosure. A plurality of users 11, 12, 14, 15 can connect via computers 31, 32, 34, 35 or a mobile electronic device 33 to the network 30. The connection can be wireless as indicated by the flash between the mobile device 33 and network 30.The network 30 is provided for a plurality of persons. The network can be used for example by female persons 11, 12, who want to retrieve information or prepare for a mammogram or other imaging techniques. Other users such as men preparing for screenings or biopsies examination can connect to the network.

The network 30 also provides a platform for a social network. After a user has registered and created a profile by entering profile data 38, the user can participate in the social network and communicate with other members of the community. The members may communicate with each other (for example user 11 with user 12) in order to exchange experiences. Since many women have already gathered experience, the information can be shared by recorded experience reports or by interactively communicating with each other. Thus, inexperienced women can feel more comfortable and be better informed, what is expected during and after the examination. Optionally, there is the possibility to communicate with healthcare professionals 14 or technicians 15, in order to receive health-related or technical information. If the healthcare professional 14 or technician 15 participate in the network, they can receive feedback from the patient or answer questions of the patient posed via the network.

The network 30 is connected to an operating system 20 via an interface 36. The operating system comprises a processor or computer 21, an application provisioning server 22, a web server 23 and a data server 24. The data server 24 provides content data comprising a plurality of data sets such as first content data 26comprising ambient parameter, second content data 27 and third content data 28. This content data 27 can comprise administrative data or time data for scheduling an appointment. Electronic medical record data are preferably retrieved from an external information system 50. This external information system comprise medical modules as a health information system (HIS) 51 and/or a radiology information system 52 (RIS). Medical data provided by the information system may be X-ray imaging data from former examinations, lab results, healthy advice and continuity of care documents.

The data server 25 may also provide recorded profile data 38, which can be associated with data of a selected ambience 26. The data server can provide a list of patients scheduled for medical examinations. The identification data 41 alone or with associated selection data 48 are sent to the control system 40. When a patient is entering a room with a personal user card 60 or any other suitable object, which comprises an identifier such as an RFID, the control system can read the identification data automatically and allocate it to the identification data 41 from the data server. In this way a personal card 60 may only comprise at least part of the profile data 38 for identification of the user, whereas the selected ambient parameter 48 may be retrieved from the control system 40. Alternatively the personal user card 60or object may comprise besides identification data 38 selected ambient data 48. In this case the control system can retrieve the selection information from the personal card 60.

The personal identification with the RFID card 60 or other suitable object as a pen, ring, wristband, electronic device can initiate a preparation of the imaging machine and a display of the patient history at the control station. In addition the scan of the user card 60 or any other RFID containing object can be advantageously used for the configuration of the system such as an automatic procedure selection and/or the adaptation of the gantry to the patient such as the patient's anatomy or a potential handicap. In this way the workflow can be improved.

The use of RFID technology enables an automatic reading by a card reader 45. The information can be retrieved wireless as indicated by the dashed arrow. In this way the user can be identified very easily. Hence, the user may relax, after having entered a medical environment such as a waiting room. Based on the identification data, the associated selected ambient parameters 48 are automatically generated by the corresponding controller 42. The control system 40 is connected to a plurality of controllers 42, 43 and 44, which generate one or more selected ambient parameter in different rooms comprising waiting room, dressing room and examination room, respectively.

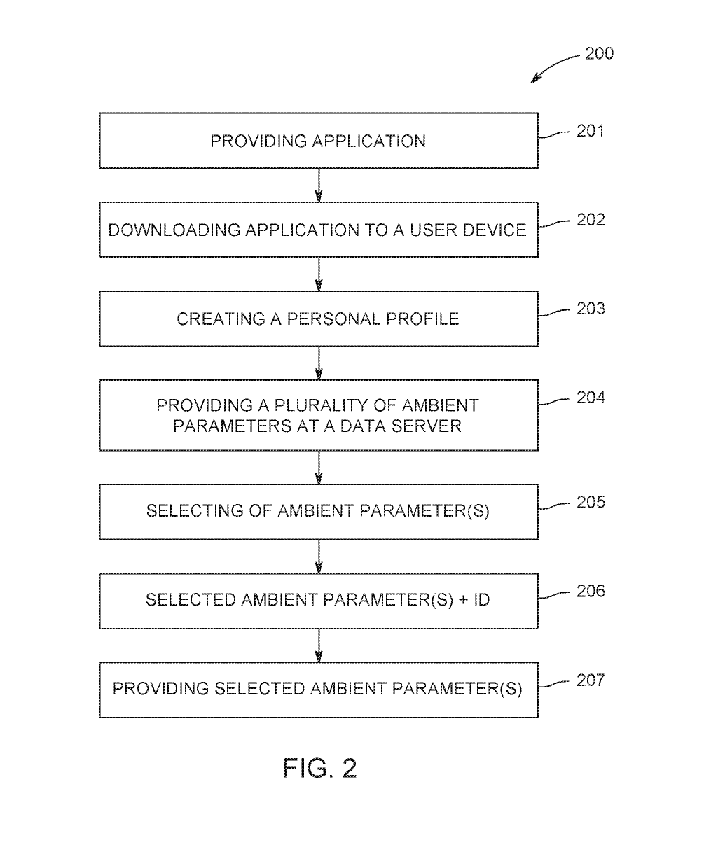

FIG. 2 depicts a flowchart for a method 200 according to the present disclosure. According to the method step 201, an application provisioning server 22 provides at least one application. In method step 202 a user requests from a user device a download of the at least one application. After downloading the application, in step 203 a personal profile comprising user specific information may be created at the user device.

In step 204, a data server provides content data comprising a plurality of ambient parameters for at least one medical environment. In the next step 205 at least one ambient parameter is selected from the plurality of ambient parameters by the user. In step 206 the at least one selected ambient parameter is associated with at least one user specific information of the personal profile. This user specific information can be used as identifier (ID).

If a patient, who has performed the above method steps enters a medical environment such as an examination room of a radiology center, a controller can provide the selected ambient parameter based on the at least one user specific information and associated selected ambient parameter.

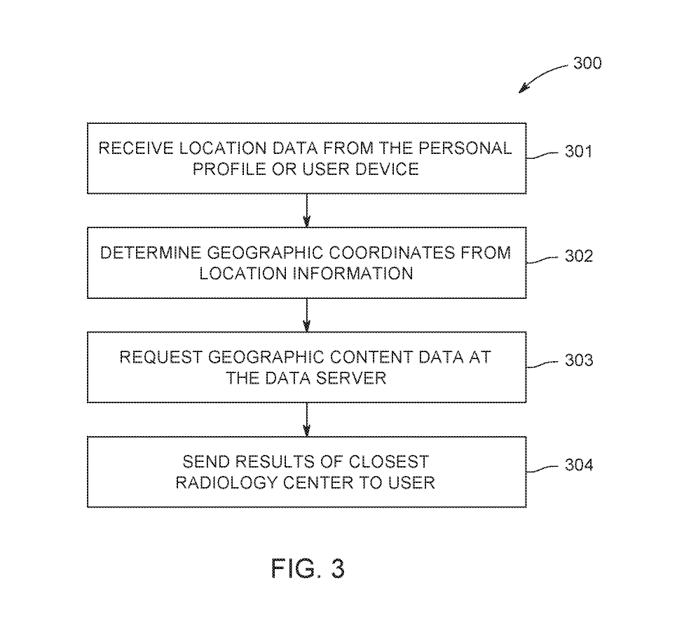

FIG. 3 shows a method 300 according to another embodiment of the disclosure. The method 300 comprises a localization process, which enables the user to find the closest radiology center. In step 301, location data is received from the personal profile or a user device such as personal computer or a portable electronic device. In step 302 the geographic coordinates are determined from the location information of the profile or the user device. For data security the location information is only available if the user has accepted to be localized. A respective agreement to be localized can be communicated by using a respective check option in the personal profile. In the following method step 303, geographic content data, which define the locations of a plurality of medical centers, are requested from the data server. This data is compared to the location data from the user. In step 304 the results of the one or more closest medical center are sent to the user. In this way the user can easily find a radiology center, which provides the possibility to select a personalized ambience.

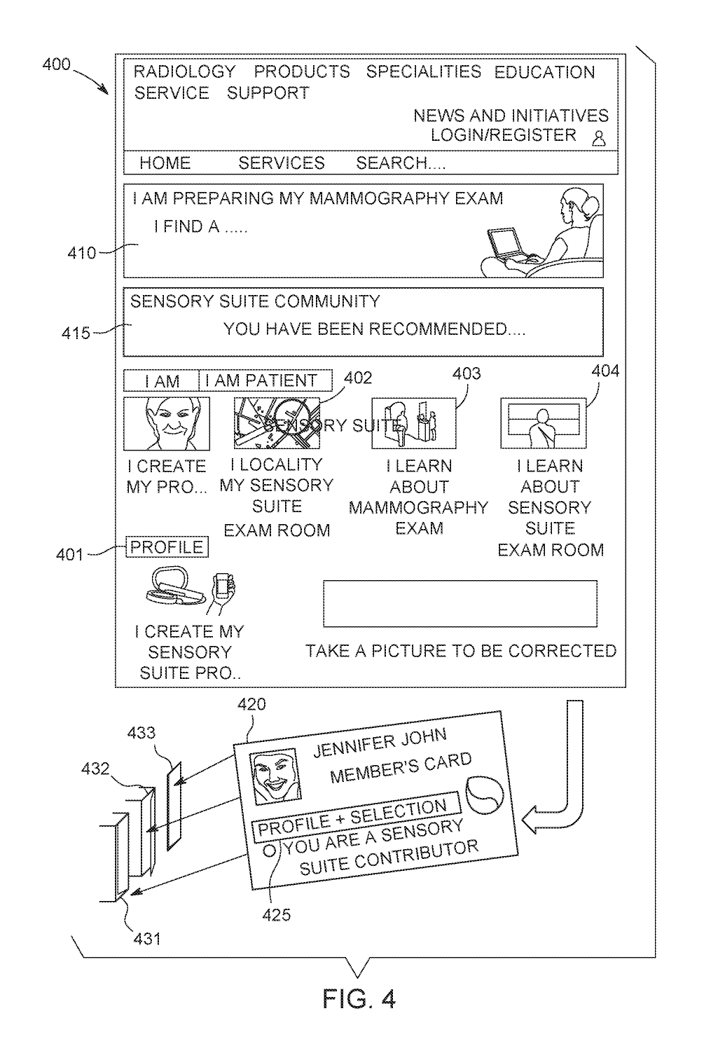

FIG. 4 illustrates an embodiment of a website 400 with applications and information regarding medical procedures and a suite of personalized patient experience/ambience options. By providing such information and applications, anxiety associated with certain medical procedures, such as mammography procedures, is reduced, which in turn encourages women to get screening mammograms on a regular basis.

The website 400 can be visited by a person or user via the internet and is provided by a webserver (see 23 in FIG. 1). In section 410 of the website, a mammography examination can be prepared for at home via a user device such as a portable computer. Section 415 represents a social network or platform. Further there are applications, which may be downloaded from the website. The application 401 can be used to create a personal profile. Further, an application for localization 402 is provided. In section 403 information about mammography systems can be retrieved.

In section 404 parameters for ambience are represented. There may be one or more ambient parameter. A seaside ambience may comprise for example a display of sand and waves. Olfactory stimuli such as a scents and/or audible signals such as music may also be provided. The different possibilities of ambient parameters can be preselected by the user. An update or change of these data is also possible.

Based on the data entered in the personal profile in section 401, a personal member card 420 may be requested by the user. This card has a memory comprising the profile data and a selection of one or more ambient parameter (indicated with the box “profile+selection”). In this way the data of selected ambient parameter need not be retrieved from the data server and the controller can be directly controlled by the member card 420. Hence the data flows can be reduced and less memory has to be provided in the local control system. If the patient carries the member card, it can be read automatically in rooms providing equipment for reading. The doors 431, 432, 433 leading to a waiting room, dressing room and examination room, respectively can be equipped such they can read and transmit the identification data of a member card 420 to a controller. In this way a controller located in the room can generate the preselected ambience or prepare the imaging system for the examination.

In a waiting room as display option a virtual window may be provided that welcomes the patient personally. If the patient is identified in the dressing room based on the selected ambience and identification data on the member card 420 a projector, a display, virtual window and/or virtual mirror can display personalized information. By providing an automatic identification there cannot be errors when allocating patient data as medical records to the patient. Hence, there is the advantage that errors due to mistaken identity and related confusion of health personnel or patients can be avoided.

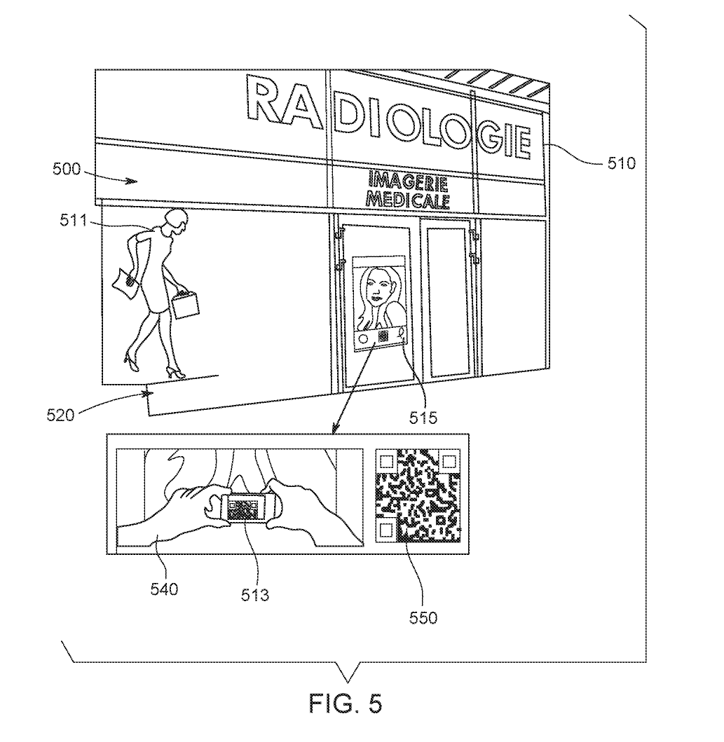

FIG. 5 shows a method 500 to connect to a network outdoors. The method comprises scanning a QR-code or flash code 550 from a poster 515 with an advertisement attached to a door entrance of a radiology center 510. Any female person 511 on the street 520 passing by the center 510 can scan with a suited mobile device or a smart phone with an application which can read the QR-code technologies 513 the QR-code 550. Afterwards a link to the website can be sent and the potential user 511 may easily connect to the network and retrieve further information. When visiting the website through the mobile phone or a computer terminal from home, the user may as next step send a download request for any application, such as for example an application for creating a personalized ambience.

This written description uses examples to disclose the invention, including the best mode, and also to enable any person skilled in the art to practice the invention, including making and using any devices and performing any incorporated methods. The patentable scope of the invention is defined by the claims, and may include other examples that occur to those skilled in the art.

What is claimed is:

1. A method for providing a personalized experience to a user in a medical environment, the method comprising:
providing at an application provisioning server at least one application;
receiving at the application provisioning server from a user device a request to download the at least one application;
downloading from the application provisioning server the at least one application over a network to the user device;
creating at the user device a personal profile comprising user specific information;
providing at a data server content data comprising a plurality of ambient parameters for at least one medical environment;
selecting at the user device at least one ambient parameter provided from the plurality of ambient parameters and associating the selected ambient parameter to at least one user specific information of the personal profile; and
providing by a controller the selected ambient parameter in at least one medical environment based on the at least one user specific information and associated selected ambient parameter.

2. The method according to claim 1, further comprising after the selection, uploading and/or storing the personal profile associated with the selected ambient parameter to the data server or a mobile electronic device comprising an identifier.

3. The method according to claim 1, further comprising automatically identifying a user in order to activate the controller based provision of user related information and/or ambient parameter in at least one medical environment.

4. The method according to claim 1, wherein the identifier is a radio frequency transponder embedded in an object comprising at least one user specific information for identifying, which information is readable by a reader comprised in the medical environment.

5. The method according to claim 1, wherein the controller provides in at least one medical environment comprising medical examination rooms, waiting rooms and dressing rooms, ambient parameters selected from a group comprising a plurality of visual, audible, tactile, olfactory and/or gustative stimuli.

6. The method according to claim 1, further providing at the data server, content data comprising administrative data, technical information, medical data, information retrievable from information system, X-ray imaging data, lab results, healthy advice, continuity of care documents and/or time usable to schedule a mammography examination.

7. The method according to claim 1, further comprising displaying content data, user specific data and/or visual information on a projector, a display, a virtual window and/or a virtual mirror in at least one medical environment.

8. The method according to claim 1, further comprising assigning the personal profile to an individual user via an authentication process in order to establish the user as a member of a social network.

9. The method according to claim 1, further comprising establishing communication in the social network, which allows the member to exchange information or communicate with one or more members of a social network.

10. The method according to claim 1, further comprising providing location data from a mobile user device or from the personal profile comprising residence or working place in order to indicate the location of the closest medical environment.

11. The method according to claim 1, further comprising connecting to the network by quick response (QR) and/or flash code technology.

12. The method according to claim 1, further comprising amending the user profile and selected ambient parameters.

13. A computer program product, which computer program product comprises program instructions for carrying out the steps of the method according claim 1, when said product is executed on a computer.

14. A computer readable medium storing program instructions, which, when executed by a computer cause the computer to perform the method according to claim 1.

15. A system for providing a personalized experience to a user in a medical environment, the system comprising
an application provisioning server configured to provide at least one application;
a user device configured to download the at least one application over a network to the user device and to create a unique personal profile comprising user specific information;
a data server configured to provide content data comprising a plurality of ambient parameters in at least one medical environment; and
a controller configured to provide user related information and/or ambient parameter for a medical environment based on selected parameter.

16. The system according to claim 15, wherein the controller is configured to provide, in at least one medical environment comprising medical examination rooms, waiting rooms and dressing rooms, ambient, parameters comprising a plurality of visual, audible, tactile, olfactory and/or gustative stimuli.

17. The system according to claim 16, wherein the data server is further configured to provide content comprising administrative data, technical information, medical data, information retrievable from information system, X-ray imaging data, lab results, healthy advice, continuity of care documents and/or time data usable in scheduling an appointment for a mammography examination.

18. The system according to claim 17, further comprising a projector, a display, a virtual window and/or a virtual mirror in at least one medical environment configured to display content data, user specific data or visual information provided by the controller.
